(19) United States
(12) Patent Application Publication
(10) Pub. No.: US 2017/0192500 A1
(43) Pub. Date: Jul. 6, 2017

(54) METHOD AND ELECTRONIC DEVICE FOR CONTROLLING TERMINAL ACCORDING TO EYE ACTION

(71) Applicants: Le Holdings (Beijing) Co., Ltd., Beijing (CN); Lemobile Information Technology (Beijing) Co., Ltd, Beijing (CN)

(72) Inventor: Jinxin Hao, Beijing (CN)

(73) Assignees: Le Holdings (Beijing) Co., Ltd., Beijing (CN); Lemobile Information Technology (Beijing) Co., Ltd ., Beijing (CN)

(21) Appl. No.: 15/247,655

(22) Filed: Aug. 25, 2016

Related U.S. Application Data
(63) Continuation of application No. PCT/CN2016/087844, filed on Jun. 30, 2016.

(30) Foreign Application Priority Data
Dec. 31, 2015 (CN) 201511026694.7

(51) Int. Cl. G06F 3/01; G06F 3/0484

(52) U.S. Cl. CPC G06F 3/013; G06F 3/04847; G06F 3/04845

(57) ABSTRACT

The present disclosure provides a method and device for controlling a terminal according to an eye action. The method includes the following steps: acquiring a coordinate range of an operable area within a display area of a terminal, the coordinate range being associated with a preset eye action, the preset eye action being associated with a control operation; recognizing a coordinates of a sight line focus of a user; monitoring whether the coordinates falls into the coordinate range or not; recognizing an eye action of the user when the coordinates falls into the coordinate range; and executing the control operation when the eye action matches the preset eye action.

### CROSS REFERENCE TO RELATED APPLICATIONS

This application is a continuation of International Application No. PCT/CN2016/087844, filed on Jun. 30, 2016, which is based upon and claims priority to Chinese Patent Application No. 201511026694.7, filed on Dec. 31, 2015, the entire contents of which are incorporated herein by reference.

### FIELD OF TECHNOLOGY

The present disclosure relates to the field of intelligent controls, and more particularly to a method and electronic device for controlling a terminal according to an eye action.

### BACKGROUND

At present, smart terminals, such as mobile phones and tablet computers, have an increasing number of functions, and generally are equipped therein with camera devices, including a front camera and a rear camera, which are typically applied to taking pictures and shooting videos. With the development of artificial intelligence technologies, the application of camera devices has been widened increasingly. For instance, a front camera can be used to collect face image information to facilitate face recognition by a terminal processor, so that the terminal can perform operations, such as unlocking, based on a face recognition technology. It thus becomes clear that under the background of the continuous improvement of the performance of the camera device, smart terminals can make use of the camera deices to offer more convenient operation ways to users.

The existing smart terminals have been able to recognize the eye action of a user and make a corresponding response according to the eye action. Specifically, a front camera is utilized to collect eye images of the user in real time, and in accordance with these continuous images, whether the user continuously blinks or not can be determined, and even the rotation magnitude of the eyeballs of the user can be recognized. Based on this technology, some terminals can be enabled to perform operations, such as closing a page when continuous blinking of the user is recognized, or turning a page when rotation of the eyeballs towards a certain direction is recognized.

As is known to all, there are typically a plurality of operable areas on a page displayed by the terminal, e.g. a virtual button area, a virtual slider area and the like. The user may click different operable areas on the touch screen and the terminal may give feedbacks of different control actions. However, according to the above-described existing solution for controlling a terminal based on an eye action, corresponding processing can be performed only according to the recognized eye actions, and the number of eye actions is relatively limited. As a consequence, for a page with a plurality of operable areas, it is impossible to enable every operable area to correspond to different one of the eye actions respectively, and instead, only some operable areas that are relatively important can be manually chosen to correspond to the eye actions. It thus can be seen that the existing solution for controlling a terminal based on an eye action has poor flexibility and cannot meet the demands of users accordingly.

### SUMMARY

Thus, the present disclosure provides a method for controlling a terminal according to an eye action and an electronic device thereof that overcome the defect of poor flexibility of the solution for controlling a terminal based on an eye action in the prior art.

One objective of embodiments of the present disclosure is to provide a method for controlling a terminal according to an eye action, characterized in including the following steps: acquiring a coordinate range of an operable area within a display area of a terminal, the coordinate range being associated with a preset eye action, the preset eye action being associated with a control operation; recognizing coordinates of a sight line focus of a user; monitoring whether the coordinates falls into the coordinate range or not; recognizing an eye action of the user when the coordinates falls into the coordinate range; and executing the control operation when the eye action matches the preset eye action.

Another objective of the embodiments of the present disclosure further provides an electronic device, including at least one processor; and a memory communicably connected with the at least one processor for storing instructions executable by the at least one processor, wherein execution of the instructions by the at least one processor causes the at least one processor to acquire a coordinate range of an operable area within a display area of a terminal, the coordinate range being associated with a preset eye action, the preset eye action being associated with a control operation; recognize coordinates of a sight line focus of a user; monitor whether the coordinates falls into the coordinate range or not; recognize an eye action of the user when the coordinates falls into the coordinate range; and execute the control operation when the eye action matches the preset eye action.

A further objective of the embodiments of the present disclosure further provides a non-transitory computer-readable storage medium storing executable instructions that, when executed by an electronic device with a touch-sensitive display, cause the electronic device to acquire a coordinate range of an operable area within a display area of a terminal, the coordinate range being associated with a preset eye action, the preset eye action being associated with a control operation; recognize coordinates of a sight line focus of a user; monitor whether the coordinates falls into the coordinate range or not; recognize an eye action of the user when the coordinates falls into the coordinate range; and execute the control operation when the eye action matches the preset eye action.

In a method and device for controlling a terminal according to an eye action provided in the present disclosure, by acquiring a coordinate range of an operable area within a display area of a terminal and then recognizing coordinates of a sight line focus of a user, a relationship of the sight line focus of the user and the operable area can be determined, i.e. what the user intends can be learned; then, which operable area the user intends to operate can be determined by monitoring the variation of the coordinates of the sight line focus and determining whether the coordinates falls into the coordinate range of a specific operable area. Finally, whether a predetermined control operation is executed can be determined by recognizing an eye action of the user. It thus can be seen that the solution described above can perform abundant control operations on the terminal in conjunction with the corresponding relationship of the sight line focus of the user and the operable area as well as the eye action of the user, and therefore this solution has good flexibility.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for controlling a terminal according to an eye action provided by one embodiment of the present disclosure;

FIG. 2 is a schematic diagram of a display area of one embodiment of the present disclosure;

FIG. 3 is a schematic diagram of the movement process of a sight line focus of a user within the display area shown in FIG. 2;

FIG. 4 is a structural diagram of a device for controlling a terminal according to an eye action provided in one embodiment of the present disclosure;

FIG. 5 is a structural diagram of a non-transitory computer-readable storage medium provided by one embodiment of the present disclosure.

FIG. 6 is a structural diagram of an electronic device provided by one embodiment of the present disclosure.

### DETAILED DESCRIPTION

In order to clearly describe objectives, the technical solutions and advantages of the present disclosure. A clear and complete description of the technical solutions in the present disclosure will be given below, in conjunction with the accompanying drawings in the embodiments of the present disclosure. Apparently, the embodiments described below are a part, but not all, of the embodiments of the present disclosure

### Embodiment 1

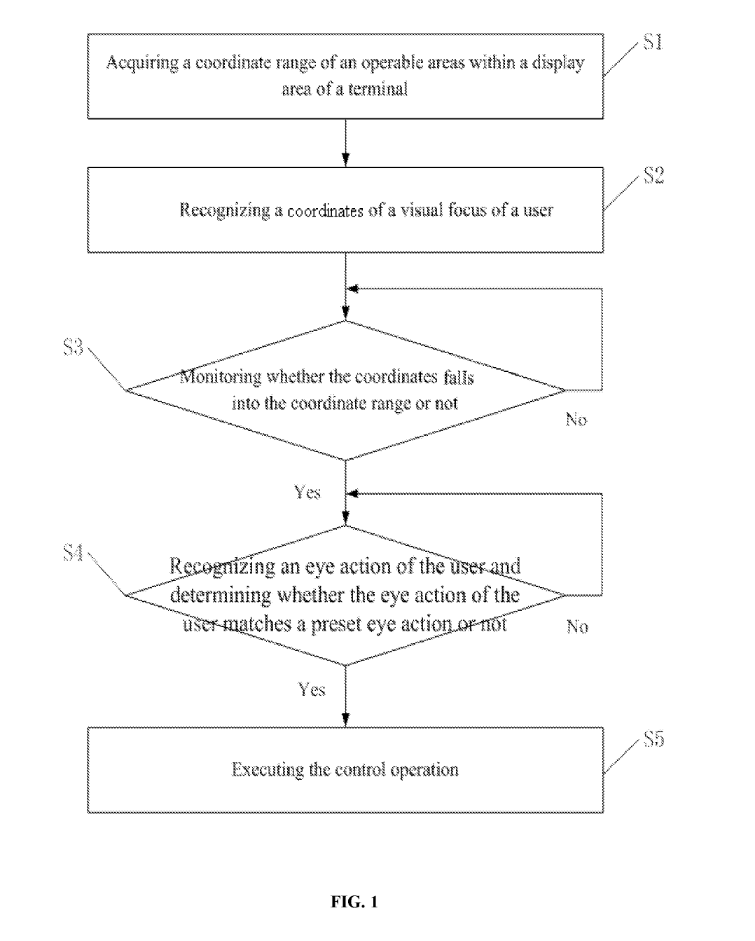

The embodiment of the present disclosure provides a method for controlling a terminal according to an eye action, which can be executed by a smart terminal having a camera device. The method, as shown in FIG. 1, includes the following steps:

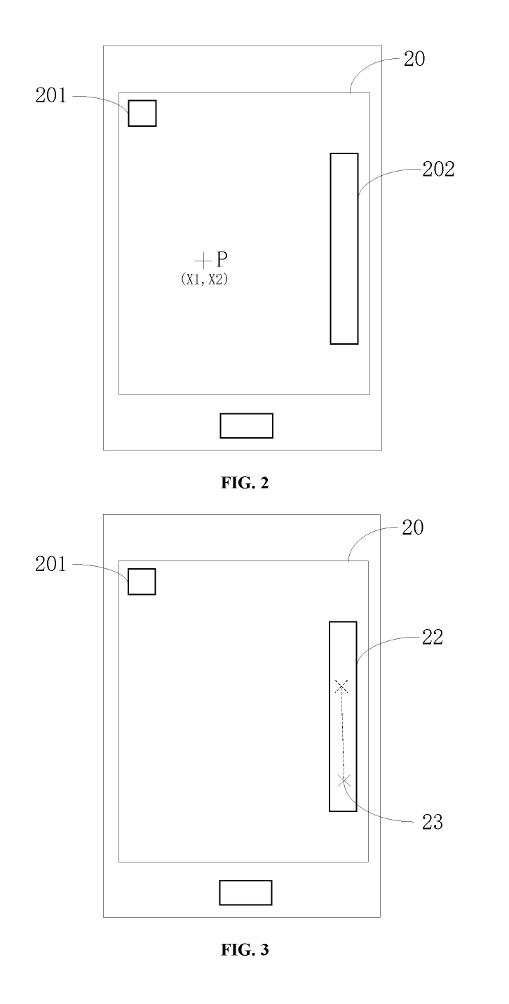

S1, acquiring a coordinate range of an operable area within a display area of a terminal, where the coordinate range is associated with a preset eye action, and the preset eye action is associated with a control operation. FIG. 2 shows a terminal display area 20, in which there are two operable areas, i.e. a first area 201 and a second area 202 respectively. It will be appreciated by those skilled in the art that the number of the operable areas is not limited to two, and yet more or less areas are possible. The first area 201 is associated with a first preset action which is associated with a first control operation; the second area 202 is associated with a second preset action which is associated with a second control operation, and the first and second preset actions described above may be the same as or different from each other, e.g. some areas may be associated with the same preset eye action when there are too many operable areas.

S2, recognizing coordinates of a sight line focus of a user. Specifically, a front camera may be used to collect images of the eyes of the user and then the sight line focus of the both eyes can be analyzed by analyzing the state of pupils in the images, and then the focus can be mapped onto a plane where the terminal display area is located. The present disclosure enables recognition for the coordinates of the sight line focus of the user through use of a variety of existing sight line focus tracking algorithms, some of which have higher recognition precision but complex calculation processes, while some of which are relatively simple but low in recognition precision. The selection of an algorithm may depend on the performance of the terminal processor. When the user watches the screen and focuses his two eyes on the screen, a focus P with the coordinates of (X1, X2) as shown in FIG. 2 can be recognized.

S3, monitoring whether the coordinates falls into the coordinate range or not; if the coordinates does not fall into the coordinate range, continuing monitoring until the coordinates falls into the coordinate range, and then executing step S4. It can be seen from the description above that in addition to two operable areas, there are other inoperable areas within the display area 20. When the coordinates of the focus P do not fall into the first area 201 or the second area 202, monitoring is continued; and the next operation is executed only when the coordinates of the focus P fall into the first area 201 or the second area 202.

S4, recognizing an eye action of the user and determining whether the eye action of the user matches a preset eye action; if so, executing a step S5; and if not, continuing to make further determination. There are many methods for recognizing eye actions, e.g. the eye action may be recognized according to either eye images or the movement of the focus P. It is preferred in the present disclosure to recognize the eye action according to the movement of the focus P, as will be specifically introduced hereinafter.

S5, executing the control operation when the eye action matches the preset eye action. FIG. 3 is a schematic diagram showing the movement of the sight line focus of the user into the operable area. When the coordinates of the focus P fall into the second area 202, the step begins with recognizing whether the eye action of the user matches the above described second preset eye action. It is assumed that the second eye action is rotating the eyeballs downwards, the above described second control operation, e.g. scrolling down a page, is executed when the user rotates his eyeballs downwards to correspondingly move the focus P downwards and the coordinates of the focus before and after its movement both fall into the operable area.

The solution provided by the present disclosure can be applied to various scenarios, such as text reading scenario. Within the display area, there may be a plurality of virtual buttons or sliders, e.g. page turning, scrolling, zooming in, zooming out, closing and the like, and these virtual buttons and sliders are operable areas. The virtual buttons, e.g. page turning, zooming in, zooming out, closing and the like, may be associated with a same preset eye action (e.g. staring, or blinking continuously); and the virtual sliders, e.g. scrolling, sliding and the like, may be associated with another preset eye action (e.g. both eyeballs rotating towards a certain direction at the same time), but the control operations associated with the preset eye actions within each operable area are different. Thus, when the user moves the sight line focus onto a zooming-in button and stares for a specific period of time, the currently displayed page is zoomed in by the terminal; when the user moves the sight line focus onto a zooming-out button and stares for a specific period of time, the currently displayed page is zoomed out by the terminal; when the user moves the sight line focus onto a closing button and stares for a specific period of time, the currently displayed page is closed by the terminal; and when the user moves the sight line focus onto a scrolling button and rotates his eyeballs, the currently displayed page is scrolled by the terminal towards the corresponding direction.

In the method for controlling a terminal according to an eye action provided by the present disclosure, by acquiring a coordinate range of operable areas within a display area of a terminal and then recognizing a coordinates of a sight line focus of a user, the relationship of the sight line focus of the user and the operable areas can be determined, i.e. What the user intends can be learned; then, which operable area the user intends to operate can be determined by monitoring variation of the coordinates of the sight line focus and determining whether the coordinates falls into the coordinate range of a certain operable area or not. Finally, whether a predetermined control operation is executed can be determined by recognizing the eye action of the user. It thus can be seen that the solution described above can perform abundant control operations on the terminal in conjunction with the corresponding relationship of the sight line focus of the user and the operable areas as well as the eye action of the user, and this solution has good flexibility.

As a preferred embodiment, the above described step S3 may include:

S31, acquiring a distance value L between eyes of the user and the display area. It will be appreciated by those skilled in the art that the magnitude of movement of the focus depends on the distance L during rotation of the eyeballs. The larger the distance value L is, the larger the magnitude of movement of the focus during rotation of the eyeballs of the user will be; and the smaller the distance value L is, the smaller the magnitude of movement of the focus during rotation of the eyeballs of the user will be.

S32, determining a sight line focus movement ratio according to the distance value. There are a wide variety of algorithms for determining this ratio value, for example, calculation may be performed according to preset functions, or a corresponding relationship may be pre-stored, e.g. a certain distance range corresponds to a ratio value, etc.

S33, acquiring current coordinates of the sight line focus of the user, monitoring a rotation magnitude value of eyeballs of the user, and determining a variation of the current coordinates according to the rotation magnitude value and the sight line focus movement ratio. The variation of the coordinates of the focus P is captured in real time according to the magnitude of rotation of the eyeballs of the user and the above distance value L, and when (X1, X2) after variation falls into the operable area, recognition for the eye action begins.

According to the abovementioned solution, the distance between the eyes of the user and the display area is captured in real time and the movement of the sight line focus of the user is captured in real time according to the distance and the magnitude of rotation of the eyeballs. This solution is high in accuracy and can satisfy the requirement of the user for controlling the terminal at different distances by means of eye actions, thus further improving the operation flexibility.

It can be seen from the description above that there may be a wide variety of eye actions of the user. And as a preferred embodiment, the abovementioned preset eye actions can be classified into two categories, i.e. a stationary action and a moving action, and in this way the difficulty in determining the preset action can be lowered. Preferably, the above step S4 may include the following sub-steps:

S41, monitoring the variation of the coordinates within the coordinate range. A time value can be predetermined here, time recording begins after the sight line focus of the user falls into the operable area, the variation of the coordinates of the sight line focus within the predetermined time is determined, and this variation in fact is the amount of movement of the sight line focus.

S42, determining the eye action of the user according to a relationship of the variation and a preset variation. If, within the predetermined time, the variation meets a certain condition, e.g. the variations of the sub-coordinates in two directions are both smaller than or larger than a certain value, then the eye action of the user is determined as a certain eye action.

Further, the above step S42 may include the following steps:

S421, determining the relationship of ΔX1 and a first preset variation Y1 and the relationship of ΔX2 and a second preset variation Y2 in the variation (ΔX1, ΔX2);

S422, if ΔX1<Y1 and ΔX2<Y2, where this relationship means that the variation of the sight line focus of the user in the operable area within the above specific period of time is very small, then determining the eye action of the user as a stationary action; and

S423, if ΔX1>Y1 and/or ΔX2>Y2, where this relationship means that the sight line focus of the user produces the movement of a particular magnitude in a certain direction (the direction is dependent on ΔX1 and ΔX2) in the operable area within the above specific time, then determining the eye action of the user as a moving action. Afterwards, the terminal may determine whether the action is the preset action and further determine whether to execute the associated control operation.

Compared with the solution for determining the eye action through eye images, the abovementioned preferred solution for determining the eye action of the user according to the amount of movement of the sight line focus of the user within the operable area has higher accuracy.

### Embodiment 2

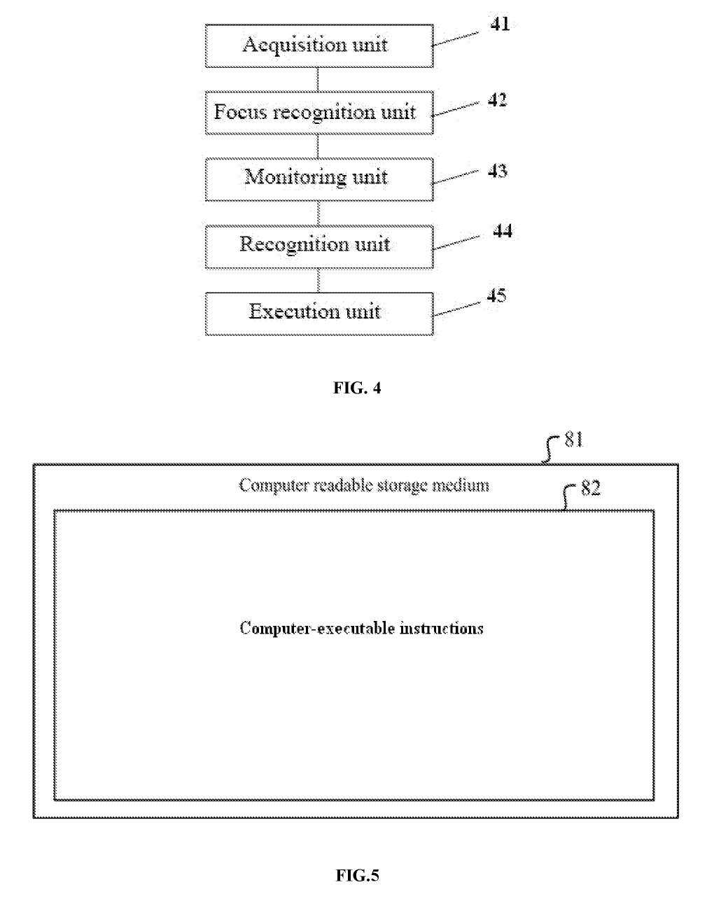

Another embodiment of the present disclosure also provides a device for controlling a terminal according to an eye action, which can be arranged in a smart terminal having a camera device. The device, as shown in FIG. 4, includes an acquisition unit 41 for acquiring a coordinate range of an operable area within a display area of a terminal, the coordinate range being associated with a preset eye action, the preset eye action being associated with a control operation. Preferably, the preset eye action includes a stationary action and a moving action; a focus recognition unit 42 for recognizing a coordinates of a sight line focus of a user; a monitoring unit 43 for monitoring whether the coordinates falls into the coordinate range or not; a recognition unit 44 for recognizing an eye action of the user when the coordinates falls into the coordinate range; and an execution unit 45 for executing the control operation when the eye action matches the preset eye action.

In the device for controlling a terminal according to an eye action provided by the present disclosure, by acquiring a coordinate range of operable areas within a display area of a terminal and then recognizing a coordinates of a sight line focus of a user, the relationship of the sight line focus of the user and the operable areas can be determined, i.e. what the user intends can be learned; then, which operable area the user intends to operate can be determined by monitoring the variation of the coordinates of the sight line focus and determining whether the coordinates falls into the coordinate range of a certain operable area. Finally, whether a predetermined control operation is executed can be determined by recognizing the eye action of the user. It thus can be seen that the solution described above can perform abundant control operations on the terminal in conjunction with the corresponding relationship of the sight line focus of the user and the operable areas as well as the eye action of the user, and this solution has high flexibility.

Preferably, the monitoring unit 43 includes a distance acquisition unit for acquiring a distance value between eyes of the user and the display area; a ratio determination unit for determining a sight line focus movement ratio according to the distance value; and a movement monitoring unit for acquiring current coordinates of the sight line focus of the user, monitoring a rotation magnitude value of eyeballs of the user, and determining the variation of the current coordinates according to the rotation magnitude value and the sight line focus movement ratio.

According to the abovementioned solution, the distance between the eyes of the user and the display area is captured in real time and the movement of the sight line focus of the user is captured in real time according to the distance and the magnitude of rotation of the eyeballs. This solution is high in accuracy and can satisfy the requirement of the user for controlling the terminal at different distances by means of eye actions, thus further improving the operation flexibility.

Preferably, the recognition unit 44 includes a variation monitoring unit for monitoring the variation of the coordinates within the coordinate range; and an action determination unit for determining the eye action of the user according to the relationship of the variation and a preset variation.

In the abovementioned preferred solution, the preset eye actions are classified into two categories, i.e. stationary and moving, and in this way the difficulty in determining the preset action can be lowered.

Preferably, the action determination unit includes a variation judgment unit for determining the relationship of ΔX1 and a first preset variation Y1 and the relationship of ΔX2 and a second preset variation Y2 in the variation (ΔX1,ΔX2);

a stationary action judgment unit for determining the eye action of the user as stationary, when ΔX1<Y1 and ΔX2<Y2; and a moving action judgment unit for determining the eye action of the user as moving when ΔX1>Y1 and/or ΔX2>Y2.

Compared with the solution for determining the eye action through eye images, the abovementioned preferred solution for determining the eye action of the user according to the amount of movement of the sight line focus of the user within the operable area has higher accuracy.

### Embodiment 3

Referring to FIG. 5, the present embodiment provides a non-transitory computer-readable storage medium 81, the computer-readable storage medium stores computer-executable instructions 82, the computer-executable instructions perform the method for controlling a terminal according to an eye action of any one of the above-mentioned method embodiments.

### Embodiment 4

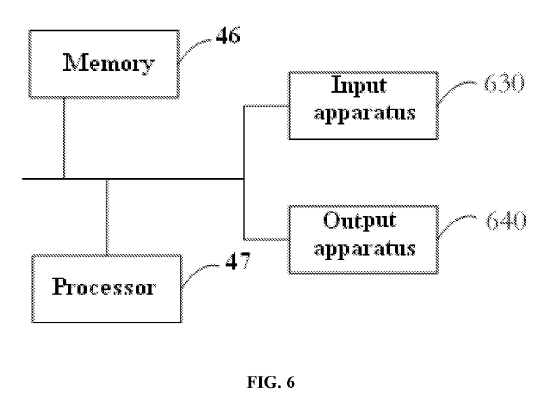

FIG. 6 is a schematic diagram of the hardware configuration of the electronic device provided by the embodiment, which performs the method for controlling a terminal according to an eye action. As shown in FIG. 6, the electronic device includes: one or more processors 47 and a memory 46, wherein one processor 47 is shown in FIG. 6 as an example.

The electronic device that performs the method for controlling a terminal according to an eye action further includes an input apparatus 630 and an output apparatus 640.

The processor 47, the memory 46, the input apparatus 630 and the output apparatus 640 may be connected via a bus line or other means, wherein connection via a bus line is shown in FIG. 6 as an example.

The memory 46 is a non-transitory computer-readable storage medium that can be used to store non-transitory software programs, non-transitory computer-executable programs and modules, such as the program instructions/modules corresponding to the method for controlling a terminal according to an eye action of the embodiments of the present disclosure (e.g. the acquisition unit 41, the focus recognition unit 42 the monitoring unit 43, the recognition unit, and the execution unit shown in the FIG. 4). The processor 47 executes the non-transitory software programs, instructions and modules stored in the memory 46 so as to perform various function application and data processing of the server, thereby implementing the Method for controlling a terminal according to an eye action of the above-mentioned method embodiments

The memory 46 includes a program storage area and a data storage area, wherein, the program storage area can store an operation system and application programs required for at least one function; the data storage area can store data generated by use of the device for controlling a terminal according to an eye action. Furthermore, the memory 46 may include a high-speed random access memory, and may also include a non-volatile memory, e.g. at least one magnetic disk memory unit, flash memory unit, or other non-volatile solid-state memory unit. In some embodiments, optionally, the memory 46 includes a remote memory accessed by the processor 47, and the remote memory is connected to the device for controlling a terminal according to an eye action via network connection. Examples of the aforementioned network include but not limited to internet, intranet, LAN, GSM, and their combinations.

The input apparatus 630 receives digit or character information, so as to generate signal input related to the user configuration and function control of the device for controlling a terminal according to an eye action. The output apparatus 640 includes display devices such as a display screen.

The one or more modules are stored in the memory 46 and, when executed by the one or more processors 47, perform the method for controlling a terminal according to an eye action of any one of the above-mentioned method embodiments.

The above-mentioned product can perform the method provided by the embodiments of the present disclosure and have function modules as well as beneficial effects corresponding to the method. Those technical details not described in this embodiment can be known by referring to the method provided by the embodiments of the present disclosure.

The electronic device of the embodiments of the present disclosure can exist in many forms, including but not limited to:

Mobile communication devices: The characteristic of this type of device is having a mobile communication function with a main goal of enabling voice and data communication. This type of terminal device includes: smartphones (such as iPhone), multimedia phones, feature phones, and low-end phones.

Ultra-mobile personal computer devices: This type of device belongs to the category of personal computers that have computing and processing functions and usually also have mobile internet access features. This type of terminal device includes: PDA, MID, UMPC devices, such as iPad.

Portable entertainment devices: This type of device is able to display and play multimedia contents. This type of terminal device includes: audio and video players (such as iPod), handheld game players, electronic books, intelligent toys, and portable GPS devices.

Servers: devices providing computing service. The structure of a server includes a processor, a hard disk, an internal memory, a system bus, etc. A server has an architecture similar to that of a general purpose computer, but in order to provide highly reliable service, a server has higher requirements in aspects of processing capability, stability, reliability, security, expandability, manageability.

Other electronic devices having data interaction function.

The above-mentioned device embodiments are only illustrative, wherein the units described as separate parts may be or may not be physically separated, the component shown as a unit may be or may not be a physical unit, i.e. may be located in one place, or may be distributed at multiple network units. According to actual requirements, part of or all of the modules may be selected to attain the purpose of the technical scheme of the embodiments.

By reading the above-mentioned description of embodiments, those skilled in the art can clearly understand that the various embodiments may be implemented by means of software plus a general hardware platform, or just by means of hardware. Based on such understanding, the above-mentioned technical scheme in essence, or the part thereof that has a contribution to related prior art, may be embodied in the form of a software product, and such a software product may be stored in a computer-readable storage medium such as ROM/RAM, magnetic disk or optical disk, and may include a plurality of instructions to cause a computer device (which may be a personal computer, a server, or a network device) to execute the methods described in the various embodiments or in some parts thereof.

Finally, it should be noted that: The above-mentioned embodiments are merely illustrated for describing the technical scheme of the present disclosure, without restricting the technical scheme of the present disclosure. Although detailed description of the present disclosure is given with reference to the above-mentioned embodiments, those skilled in the art should understand that they still can modify the technical scheme recorded in the above-mentioned various embodiments, or substitute part of the technical features therein with equivalents. These modifications or substitutes would not cause the essence of the corresponding technical scheme to deviate from the concept and scope of the technical scheme of the various embodiments of the present disclosure.

What is claimed is:

1. A method for controlling a terminal according to an eye action, comprising the following steps:
acquiring a coordinate range of an operable area within a display area of a terminal, the coordinate range being associated with a preset eye action, the preset eye action being associated with a control operation;
recognizing coordinates of a sight line focus of a user;
monitoring whether the coordinates falls into the coordinate range or not;
recognizing an eye action of the user when the coordinates falls into the coordinate range; and
executing the control operation when the eye action matches the preset eye action.

2. The method of claim 1, wherein monitoring whether the coordinates falls into the coordinate range or not comprises:
acquiring a distance value between eyes of the user and the display area;
determining a sight line focus movement ratio according to the distance value; and
acquiring current coordinates of the sight line focus of the user, monitoring a rotation magnitude value of eyeballs of the user, and determining a variation of the current coordinates according to the rotation magnitude value and the sight line focus movement ratio.

3. The method of claim 1, wherein the preset eye action comprises a stationary action and a moving action.

4. The method of claim 3, wherein recognizing an eye action of the user comprises:
monitoring the variation of the coordinates within the coordinate range; and
determining the eye action of the user according to a relationship of the variation and a preset variation.

5. The method of claim 4, wherein determining the eye action of the user according to the relationship of the variation and a preset variation comprises:
determining the relationship of ΔX1 and a first preset variation Y1 and the relationship of ΔX2 and a second preset variation Y2 in the variations (ΔX1, ΔX2);
if ΔX1<Y1 and ΔX2<Y2, then determining the eye action of the user as a stationary action; and
if ΔX1>Y1 and/or ΔX2>Y2, then determining the eye action of the user as a moving action.

6. An electronic device, comprising
at least one processor; and
a memory communicably connected with the at least one processor for storing instructions executable by the at least one processor, wherein execution of the instructions by the at least one processor causes the at least one processor to:
acquire a coordinate range of an operable area within a display area of a terminal, the coordinate range being associated with a preset eye action, the preset eye action being associated with a control operation;
recognize coordinates of a sight line focus of a user;
monitor whether the coordinates falls into the coordinate range or not;
recognize an eye action of the user when the coordinates falls into the coordinate range; and
execute the control operation when the eye action matches the preset eye action.

7. The electronic device of claim 6, wherein monitoring whether the coordinates falls into the coordinate range or not comprises:
acquiring a distance value between eyes of the user and the display area;
determining a sight line focus movement ratio according to the distance value; and
acquiring current coordinates of the sight line focus of the user, monitoring a rotation magnitude value of eyeballs of the user, and determining a variation of the current coordinates according to the rotation magnitude value and the sight line focus movement ratio.

8. The electronic device of claim 7, wherein the preset eye action comprises a stationary action and a moving action.

9. The electronic device of claim 8, wherein recognizing an eye action of the user comprises:
monitoring the variation of the coordinates within the coordinate range; and
determining the eye action of the user according to a relationship of the variation and a preset variation.

10. The electronic device of claim 9, wherein determining the eye action of the user according to the relationship of the variation and a preset variation comprises:
determining the relationship of ΔX1 and a first preset variation Y1 and the relationship of ΔX2 and a second preset variation Y2 in the variations (ΔX1, ΔX2);
if ΔX1<Y1 and ΔX2<Y2, then determining the eye action of the user as a stationary action; and
if ΔX1>Y1 and/or ΔX2>Y2, then determining the eye action of the user as a moving action.

11. A non-transitory computer-readable storage medium storing executable instructions that, when executed by an electronic device, cause the electronic device to:
acquire a coordinate range of an operable area within a display area of a terminal, the coordinate range being associated with a preset eye action, the preset eye action being associated with a control operation;
recognize coordinates of a sight line focus of a user;
monitor whether the coordinates falls into the coordinate range or not;
recognize an eye action of the user when the coordinates falls into the coordinate range; and
execute the control operation when the eye action matches the preset eye action.

12. The non-transitory computer-readable storage medium of claim 11, wherein monitoring whether the coordinates falls into the coordinate range or not comprises:
acquiring a distance value between eyes of the user and the display area;
determining a sight line focus movement ratio according to the distance value; and
acquiring current coordinates of the sight line focus of the user, monitoring a rotation magnitude value of eyeballs of the user, and determining a variation of the current coordinates according to the rotation magnitude value and the sight line focus movement ratio.

13. The non-transitory computer-readable storage medium of claim 12, wherein the preset eye action comprises a stationary action and a moving action.

14. The non-transitory computer-readable storage medium of claim 13, wherein recognizing an eye action of the user comprises:
monitoring the variation of the coordinates within the coordinate range; and
determining the eye action of the user according to a relationship of the variation and a preset variation.

15. The non-transitory computer-readable storage medium of claim 14, wherein determining the eye action of the user according to the relationship of the variation and a preset variation comprises:
determining the relationship of ΔX1 and a first preset variation Y1 and the relationship of ΔX2 and a second preset variation Y2 in the variations (ΔX1, ΔX2);
if ΔX1<Y1 and ΔX2<Y2, then determining the eye action of the user as a stationary action; and
if ΔX1>Y1 and/or ΔX2>Y2, then determining the eye action of the user as a moving action.
